(19) United States
(12) Patent Application Publication
(10) Pub. No.: US 2009/0037010 A1
(43) Pub. Date: Feb. 5, 2009

(54) Communication Driver

(75) Inventors: Seiichi Kawano, Tokyo (JP); Kenji Suzuki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSIBISHI ELECTRIC CORPORATION, Chiyoda-ku (JP)

(21) Appl. No.: 11/887,544

(22) PCT Filed: Mar. 31, 2005
(86) PCT No.: PCT/JP2005/006374

§ 371 Date: Nov. 9, 2007

(51) Int. Cl. G06F 19/00

(52) U.S. Cl. 700/96

(57) ABSTRACT

To obtain a communication driver performing data conversion between a equipment and a management unit even when different data formats are used in a manufacturing system, in which the equipment that is equipped with a device for controlling a machine based on an instruction from the management unit and the management unit having a management application program that manages the equipment are connected to the machine, the communication driver includes device drivers (51a, 51b) provided for each type of devices (22a, 22b) in the manufacturing system and controlling communications with the devices (22a, 22b), and equipment drivers (52A, 52B) provided for each type of machines (21A, 21B) in the manufacturing system and accessing the machines (21A, 21B) to be accessed by using the device drivers (51a, 51b) in accordance with an instruction from the management application program (31). The device drivers (51a, 51b) and the equipment drivers (52A, 52B) are hierarchized.

### TECHNICAL FIELD

The present invention relates to a communication driver that converts data communicated between a equipment and a management unit in a manufacturing system in which the equipment equipped with a machine such as a transporting machine, a manufacturing machine, or an inspecting machine in a manufacturing factory, and a device that controls the machine, and the management unit that manages the equipment are connected to each other via a network.

### BACKGROUND ART

Up to now, there has been proposed and popularized a flexible production system having a structure in which facilities to be controlled and a control unit are connected to each other via a network. The facilities to be controlled include diverse machine tools that actually engage in working, cleaning, and transport of a workpiece as production facilities, an arranging unit, a cleaning unit, an operation instructing unit, and a transport unit. The control unit integrally controls the operation of the facilities to be controlled while processing basic information such as a process scheduling, process order information, or scheduled jig information to prepare an operation schedule. As an example of the above flexible production system, there is a system in which the control unit is divided into plural control units for each of the functional elements of the facilities to be controlled, and the operation of the facilities to be controlled is controlled in each of the functional elements. Also, in the system, a communication line for control information transmission used for controlling the operation of the facilities to be controlled and a communication line for operation information transmission used for controlling the operation of the flexible production system are disposed, separately, to smooth a flow of the information in the entire system with high efficiency (for example, refer to Patent Document 1)

Patent Document 1: Japanese Patent No. 2577600

### DISCLOSURE OF THE INVENTION

### Problem to be Solved by the Invention

In the flexible production system disclosed in the above Patent Document 1, there are many cases in which the facilities to be controlled and the control units which are supplied from different vendors are combined together. In this case, because the meanings of parameters that are set in the facilities to be controlled, and data formats that are used in the facilities to be controlled and the control units are different among the vendors, there has arisen such a problem that the control units need a data access program for each of the facilities to be controlled whose operation is controlled by the control units. In addition, there has arisen such a problem that a heavy load is exerted on an operator that operates the data access program because a work for developing the data access program is required for each of the facilities to be controlled.

The present invention has been made in view of the above circumstances, and therefore an object of the present invention is to provide a communication driver that converts data so as to communicate the data between a equipment and a management unit even in a case where data formats that are used in the equipment and the management unit are different from each other, or even in a case where the meaning of a parameter set in the equipment is different among the vendors, in a manufacturing system in which the equipment that engages in manufacture and the management device that controls the management are connected to each other via a network.

### Means for Solving the Problems

In order to achieve the above-mentioned object, the present invention provides a communication driver that converts data which is communicated between a management unit and a equipment in a manufacturing system,

the equipment that is equipped with a device that controls a machine based on an instruction from the management unit and the management unit having a management application program that manages the equipment being connected to the machine that conducts a given processing via a network,

an output from the management application program being converted into a format that can be processed by the equipment to make the equipment execute the given processing,

the communication driver including:
a device driver that is provided for each kind of devices arranged in the manufacturing system, and controls communications with the device; and
a equipment driver that is provided for each kind of machines arranged in the manufacturing system, and accesses the machine to be accessed with the use of the device driver according to an instruction from the management application program,

in which the device driver and the equipment driver are hierarchized.

### EFFECT OF THE INVENTION

According to the present invention, the driver has a structure in which a device driver that controls communications with the device and a equipment driver that controls the unit are hierarchized. With the above configuration, there is an advantage in that the device driver of the device can be supplied by a device maker, and the equipment driver of the machine can be supplied by a machine maker, separately.

### BRIEF DESCRIPTION OF THE DRAWINGS

FIG. 1 is a diagram schematically showing an example of a manufacturing system to which the present invention is applied.

FIG. 2 is a diagram schematically showing a driver configuration of a data conversion unit.

FIG. 3 is a diagram showing a device driver and a equipment driver which are modeled according to a first embodiment.

FIG. 4 is a diagram showing the outline of a function object model based on a class diagram of an UML.

FIG. 5 is a diagram schematically showing the configuration of a communication driver according to a second embodiment of the present invention.

FIG. 6 is a diagram schematically showing the configuration of a communication driver in a case where the hierarchization of the driver is applied to a process management.

FIG. 7 is a diagram showing a production example of a function object in a case where the driver is produced with the process management as a unit.

FIG. 8-1 is a diagram schematically showing a shared interface of the drivers and a driver access procedure thereof (No. 1).

FIG. 8-2 is a diagram schematically showing the shared interface of the drivers and the driver access procedure thereof (No. 2).

FIG. 8-3 is a diagram schematically showing the shared interface of the drivers and the driver access procedure thereof (No. 3).

FIG. 8-4 is a diagram schematically showing the shared interface of the drivers and the driver access procedure thereof (No. 4).

FIG. 8-5 is a diagram schematically showing the shared interface of the drivers and the driver access procedure thereof (No. 5).

FIG. 8-6 is a diagram schematically showing the shared interface of the drivers and the driver access procedure thereof (No. 6).

FIG. 8-7 is a diagram schematically showing the shared interface of the drivers and the driver access procedure thereof (No. 7).

FIG. 8-8 is a diagram schematically showing the shared interface of the drivers and the driver access procedure thereof (No. 8).

FIG. 8-9 is a diagram schematically showing the shared interface of the drivers and the driver access procedure thereof (No. 9).

FIG. 9 is a diagram showing an example in which an XML data model for describing design information in an XML profile is described in a UML class diagram.

FIG. 10 is a diagram showing an example of an XML data model that adds an instance information model to the XML data model of the design information shown in FIG. 9.

FIG. 11 is a diagram showing an example in which the design information and configuration information are described based on the XML data model shown in FIG. 10.

FIG. 12 is a diagram showing an example of a mapping model on the design information of an IDL and the XML data.

FIG. 13 is a diagram showing an example of a producing procedure and a setting procedure of a protocol interface portion of a communication driver which is capable of referring to the instance information.

FIG. 14 is a diagram showing an example of the description of the XML profile of the interface information.

FIG. 15 is a diagram showing an example of the description pattern of the XML profile of an IDL interface portion.

FIG. 16 is a diagram showing an example of a description rule in the XML profile of the IDL data type declaration.

FIG. 17 is a diagram showing an example of the IDL description corresponding to the description of the class information of the XML profile shown in FIG. 14.

### DESCRIPTION OF REFERENCE NUMERALS

1 MANUFACTURING SYSTEM
2 EQUIPMENT
3 MANUFACTURING EXECUTION SYSTEM
4 DESIGN INFORMATION STORAGE UNIT
5 DATA CONVERSION UNIT
6 NETWORK
21 MACHINE
22 DEVICE
31 MANUFACTURING EXECUTION APPLICATION PROGRAM
51 DEVICE DRIVER
52 EQUIPMENT DRIVER
211, 221 FUNCTION
511 DEVICE OBJECT
512, 522 FUNCTION OBJECT
521 EQUIPMENT OBJECT

### BEST MODE FOR CARRYING OUT THE INVENTION

Hereinafter, a description will be given in detail of a communication driver according to preferred embodiments of the present invention with reference to the accompanying drawings.

### First Embodiment

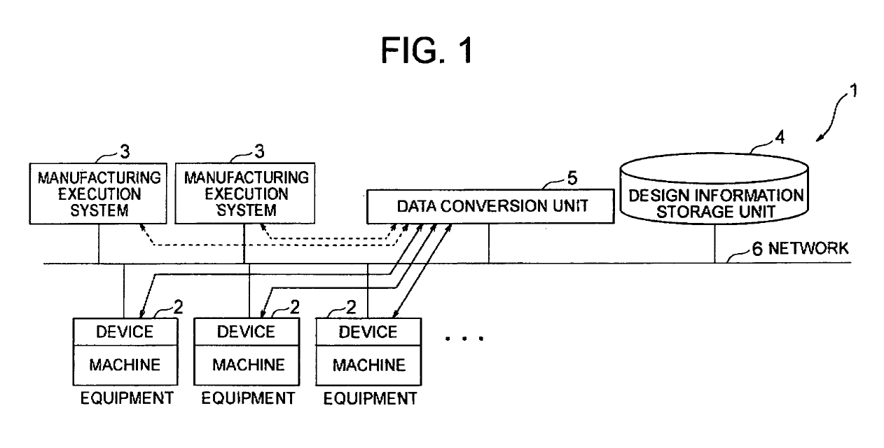

FIG. 1 is a diagram schematically showing an example of a manufacturing system to which the present invention is applied. A manufacturing system 1 is configured in such a manner that equipments 2 that execute given operation that engages in the manufacture of a certain product in the manufacturing system 1, manufacturing execution systems (MESs) 3 that manage those equipments 2, a design information storage unit 4 that stores design information such as the specifications or the project book of the equipments 2 or the manufacturing execution systems 3, and a data conversion unit 5 that converts data which is transferred between the equipments 2 and the manufacturing execution systems 3 are connected to each other via a network 6 that transmits the data.

Each of the equipments 2 includes a machine 21 that actually conducts given processing in the manufacture, and a device 22 that operates the machine 21 according to a given program and a parameter and communicates with the manufacturing execution systems 3. Each of the devices 22 includes a controller that controls the machine 21 as well as a sensor and an actuator. The equipment 2 constitutes, for example, a transport unit that transports parts for manufacturing a certain product, a manufacturing unit that manufactures the product by use of the transported parts, or an inspection unit that inspects the manufactured unit.

The manufacturing execution system 3 is a unit that executes a manufacturing execution application program for manufacturing performance management, facility maintenance, operator management, process management, quality management, manufacturing instruction, data collection, or physical distribution control, communicates with the respective equipments 2 through the network 6, and instructs the execution of data collection, transfer of data such as recipe, or parameter setting. The manufacturing execution system 3 of the above configuration is constituted by an information processing terminal such as a work station or a personal computer, including storing means for storing the manufacturing execution application program, process executing means for executing a process according to the manufacturing execution application program, and communicating means that functions as an interface with the network 6.

The design information storage unit 4 is a unit that stores design information related to the respective equipments 2 and the respective manufacturing execution systems 3, and supplies the design information that is instructed from the data conversion unit 5. The design information can be exemplified by a unit specification that is the specification of the equipments 2, a manufacturing execution system specification that is the specification of the manufacturing execution system 3, a device specification that is the specification of the devices 22 which are disposed in the equipments 2, or a facility connection specification that is the specification of a program which is set in the manufacturing execution system 3.

The data conversion unit 5 has a function of absorbing a difference in protocols or a difference in user data definitions which is caused by a difference of vendors or the models in the data that is communicated between the equipments 2 and the manufacturing execution system 3 based on the design information that is stored in the design information storage unit 4, and converting the data into a data format of the type that can be read by a unit at the data receiving side (the equipments 2 or the manufacturing execution system 3).

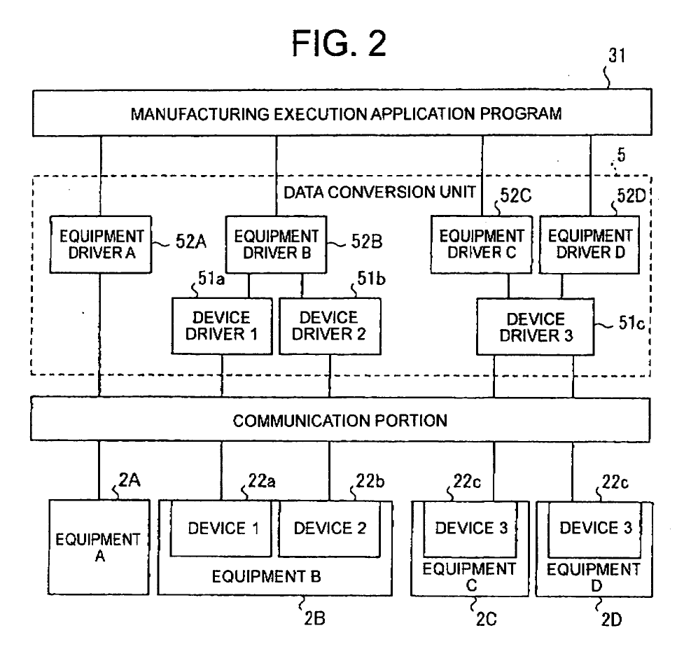

FIG. 2 is a diagram schematically showing the configuration of a driver of the data conversion unit according to the first embodiment. The figure shows a case in which the data conversion unit 5 is connected to a manufacturing execution application program 31 that is installed in one manufacturing execution system 3, and four equipments 2A to 2D of different kinds. Also, the equipment 2B has two devices 22a and 22b, and the equipments 2C and 2D have identical devices 22c. As shown in FIG. 2, the data conversion unit 5 includes device drivers 51a to 51c that control communications with the devices 22a to 22c of the equipments 2A to 2D, and equipment drivers 52A to 52D that supply the data of the equipments 2A to 2D to the manufacturing execution application program 31 of the manufacturing execution system 3 with the use of the device drivers 51a to 51c in a hierarchical fashion.

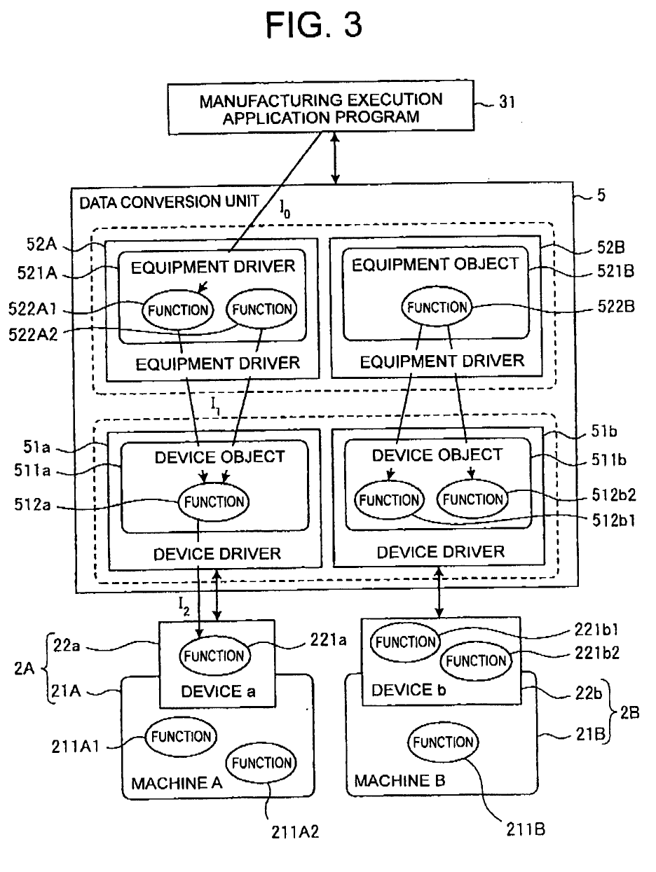

Now, a description will be given of a general model of producing the hierarchized drivers that are provided in the data conversion unit 5. FIG. 3 is a diagram showing the modeled configuration of the device drivers and the equipment drivers according to the first embodiment. In this example, the data conversion unit 5 is connected to the manufacturing execution application program 31 that is installed in one manufacturing execution system 3, and two equipments 2A and 2B of different kinds. The equipment 2A is made up of a machine 21A having two functions 211A1 and 211A2, and a device 22a having one function 221a, and the equipment 2B is made up of a machine 21B having one function 211B, and a device 22b having two functions 221b1 and 221b2.

The device drivers 51a and 51b of the data conversion unit 5 have one or more device objects 511a and 511b corresponding to the devices 22a and 22b of the communicating equipments 2A and 2B. Also, the device objects 511a and 511b have one or more function objects 512a, 512b1, and 512b2 corresponding to the functions of the devices 22a and 22b. The function objects 512a, 512b1, and 512b2 of the device objects 511a and 511b are classified by using the function object models.

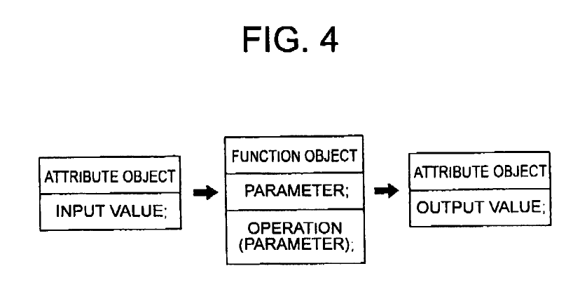

FIG. 4 is a diagram showing an outline of the function object model based on a class diagram of a UML (unified modeling language). The functions 211 and 221 of the machine 21 and the device 22 shown in FIG. 3 are set by setting the parameters of the function objects. Also, the operation of the functions 211 and 221 is conducted by the operation of the function object. The operation is conducted by setting the option setting or the setup data as the parameter and calling the parameter. The results of the operation are set to the parameter of the operation, likewise, and then returned as a reply. The function objects have attribute objects of input and output. A mode setting or an input value with respect to the functions 211 and 221 is set to the input, and a state monitor of the functions 211 and 221 or an output value is read to the output. The attribute object is used for data of the functions 211 and 221 that are periodically or cyclically updated.

When the function objects 512a, 512b1, and 512b2 of the respective device objects 511a and 511b which have been modeled by the above function object model are installed in the device drivers 51a and 51b, and then accessed, the device drivers 51a and 51b can communicate with the corresponding devices 22a and 22b, write data into the device 22a or 22b, acquire data from the device 22a or 22b, and further start up the operation of the devices 22a and 22b.

The equipment drivers 52A and 52B of the data conversion unit 5 have one or more equipment objects 521A and 521B corresponding to the communicating machines 21. Also, the equipment objects 521A and 521B have one or more function objects 522A1, 522A2, and 522B corresponding to the functions 211A1, 211A2, and 211B of the machine 21. The function objects 522A1, 522A2, and 522B of the equipment objects 521A and 521B are also classified by using the function object model based on the class diagram of the UML shown in FIG. 4 as in the case of the device drivers 51a and 51b. When the respective function objects 522A1, 522A2, and 522B which have been modeled by the above function object model are installed in the equipment drivers 52A and 52B, and then accessed, the equipment drivers 52A and 52B can write and read the attribute with respect to the function objects 512a, 512b1, and 512b2 of the device drivers 51a and 51b corresponding to the functions 211A1, 211A2, and 211B of the machines 21A and 21B. As a result, it is possible to conduct the read and write′ and operation of the data with respect to the equipments 2A and 2B that are equipped with the corresponding devices 22a and 22b.

More specifically, for example, when attention is paid to the device 22 in FIG. 3, the two device objects 511a and 511b are produced in correspondence with the two devices 22a and 22b. Also, since the device 22a has the one function 221a, the device object 511a has the one function object 512a, and since the device 22b has the two functions 221b1 and 221b2, the device object 511b has the two function objects 512b1 and 512b2.

In addition, when attention is paid to the machine 21, the equipment object 521A has the two function objects 522A1 and 522A2 in correspondence with the functions 211A1 and 211A2 of the machine 21A, and the equipment object 521B has the one function object 522B in correspondence with the function 211B of the machine 21B.

In the example of FIG. 3, the device object 511 is set as one device driver 51, and the equipment object 521 is set as the one unit drier 52. However, the present invention is not limited to the above configuration. For example, when the functions 221 of the plural kinds of devices 22 can be extracted in a broader conceptual fashion, one device object can be allocated to the plural kinds of devices 22. Similarly, in the case of the equipment object 521, when the functions 221 of the plural kinds of machines 21 can be extracted in the broader conceptual fashion, one equipment object 521 can be allocated to the plural kinds of machines 21. In those cases, it is unnecessary to prepare the device drivers 51 and the equipment drivers 52 according to the kinds of devices 22 and machines 21 as shown in FIG. 2.

As described above, when the function objects 512 and 522 are produced based on the function object model in the device object 511 and the equipment object 521, the device driver 51 and the equipment driver 52 can be hierarchized and configured as shown in FIG. 2. That is, as shown in FIG. 2, the data conversion unit 5 needs to be configured so as to provide the equipment drivers 52A to 52D corresponding to the kinds of the equipments 2A to 2D, and the device drivers 51a to 51c corresponding to the kinds of the devices 22a to 22c that are installed in the equipments 2A to 2D. The combinations of the machine 21 and the device 22 in the equipment 2 can be dealt with by the smallest number of drivers. For example, although the equipments 2C and 2D use the same devices 22c, it is necessary to provide the data conversion unit 5 with only one device driver 51c corresponding to one kind of device 22c. Also, a supplier of the machine 21 just has to provide the equipment driver 52 based on the function object model shown in FIG. 4 corresponding to the machine 21, and a supplier of the device 22 just has to provide the device driver 51 based on the function object model shown in FIG. 4 corresponding to the device 22.

Subsequently, a description will be given of a data conversion procedure in the data conversion unit 5 having the driver with the above hierarchical configuration. In this example, in FIG. 3, a case in which the manufacturing execution application program 31 accesses the function 211A1 of the equipment 2A is exemplified. First, the manufacturing execution application program 31 issues an instruction I₀ to the equipment 2A so as to execute a processing T using the function 211A1.

The instruction I₀ indicating that the processing T is executed is input to the unit drier 52A of the data conversion unit 5. The function object 522A1 of the equipment driver 52A corresponding to the function 211A1 of the equipment 2A issues an instruction I₁ for executing the processing T by the aid of the equipment 2A to the device driver 51a corresponding to the function object 522A1. That is, the function object 522A1 converts the instruction I₀ that is input for executing the processing T into the instruction I₁ that can be processed by the corresponding equipment 2A, and then outputs the converted instruction.

When the instruction I₁ indicating that the processing T is implemented by the equipment 2A is input to the device driver 51a, the function object 512a of the device driver 51a corresponding to the function 221a of the device 22a which is incorporated into the equipment 2A converts the contents of the instruction I₁ into an instruction (signal) 12 that is recognizable by the device 22a of the equipment 2A, and transmits the instruction I₂ to the device 22a of the equipment 2A that is connected on the network. The device 22a of the equipment 2A controls the machine 21A and collects the data based on the instruction (signal) I₂. The same processing is conducted on a flow of the data in the reverse direction.

Up to now, the kind of the combination of the machine 21 with the device 22 that is equipped in the machine 21 is different, it is necessary to provide the data conversion unit 5 with the drivers different for each of the equipments 2. On the other hand, according to the first embodiment, the driver is so configured as to be hierarchized into the device driver 51 that controls communications with the device and the equipment driver 52 that controls the unit. As a result, there is an advantage in that the device driver 51 of the device 22 can be provided by a device maker, and the equipment driver 52 of the machine 21 can be provided by a machine maker, separately. Also, even when the different device 22 is used, it is possible to share an interface of the driver.

### Second Embodiment

In the first embodiment, the device drivers and the equipment drivers are hierarchized in the data conversion unit. However, not only the drivers are hierarchized due to the above classification but also the drivers of the data conversion unit can be hierarchized from another viewpoint.

Up to now, the manufacturing execution application program acquires manufacturing process information from plural different devices, and issues a manufacturing instruction. However, because the protocol and the data structure are different among the equipments, the manufacturing execution application program is required to conduct communication control and the data conversion with respect to the respective equipments, and the structure management of the equipments 2 that constitutes the manufacturing process. As a result, it is difficult to generalize the manufacturing execution application program. Under the circumstances, in the second embodiment, a description will be given of another example of the hierarchization of the drivers that are capable of generalizing the manufacturing execution application program.

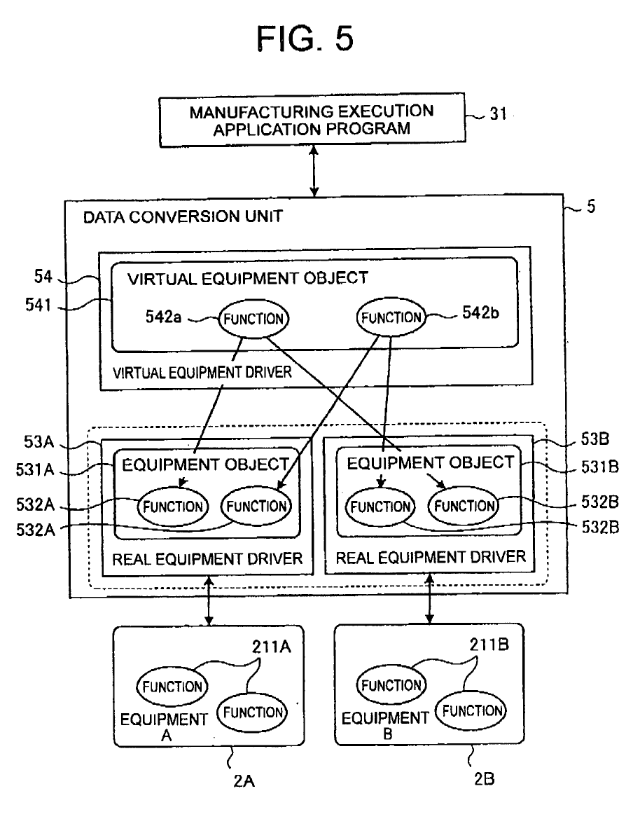

FIG. 5 is a diagram schematically showing a communication driver according to the second embodiment of the present invention. In this example, in the manufacturing system having the plural equipments 2, the drivers are hierarchized so that the manufacturing execution application program 31 recognizes the plural equipments 2 as one virtual equipment (hereinafter referred to as “virtual equipment”) and processes the virtual equipment. As in the first embodiment, the data conversion unit 5 is connected to the manufacturing execution application program 31 of the manufacturing execution system and the plural equipments 2A, 2B in which the machines are provided with the devices on the network.

The data conversion unit 5 is constituted by real equipment drivers 53A, 53B, and a virtual equipment drive 54, which are hierarchized. The real equipment drivers 53A and 53B are provided for the corresponding equipments 2A and 2B, and conducts an access to and communications with the equipments 2A and 2B. The virtual equipment driver 54 converts an instruction (processing) from the manufacturing execution application program 31 into an instruction (processing) corresponding to the functions of the individual equipments 2A and 2B, and supplies the unit data to the manufacturing execution application program 31 by the aid of the plural real equipment drivers 53A and 53B.

In this example, the real driver 53 is constituted by the combination of the device driver 51 and the equipment driver 52 in the first embodiment. The real driver 53 is equipped in the data conversion unit 5 for each of the combinations of the machine 21 and the device 22, that is, for each of the equipments 2. The real equipment driver 53 has at least one equipment object 531 corresponding to the communicating equipment 2, and the equipment object 531 has function objects 532 for each of the functions of the equipment 2. The real equipment drivers 53 associate the instances of the function objects of the equipment objects 531 with the functions of the respective equipments 2. For that reason, the real equipment drivers 53 can communicate with the equipments 2 so as to write data into the equipments 2 and acquire the data from the equipments 2.

Also, the virtual equipment driver 54 is a driver that is virtually produced so that the manufacturing execution application program 31 can deal with the plural equipments 2 as one virtual equipment. The virtual equipment driver 54 has at least one virtual equipment object 541 corresponding to the communicating equipments 2. The virtual equipment object 541 further includes at least one function object 542 corresponding to the function 211 (function object 532) of the equipment 2 (real equipment driver 53). The virtual equipment driver 54 associates the processing conducted from the manufacturing execution application program 31 to the equipments 2 with the instances of the function objects 542 of the virtual equipment object 541 and the instances of the function objects 532 of the real equipment drivers 53. For that reason, the virtual equipment driver 54 is capable of writing and reading the attribute with respect to the function objects 532 of the real equipment driver 53 corresponding to the function 211 of the equipment 2. Further, the virtual equipment driver 54 is capable of conducting the read and write and operation of the data with respect to the equipment 2 that is equipped with the corresponding device.

Since the operating process of the data conversion unit 5 configured as described above is the same as that in the case of the first embodiment, and therefore its outline will be described. For example, when an instruction for executing a processing that is going to be resultantly obtained is issued by the manufacturing execution application program 31, the function object 542 corresponding to the processing of the virtual equipment driver 54 of the data conversion unit 5 reanalyzes the instruction to a more specific instruction, and delivers the specific instruction to the corresponding function object 532 of the real equipment driver 53. The function object 532 further converts the specific instruction into an instruction (signal) of the format that can be processed by the individual equipments 2. Then, given processings such as the control of the equipments 2 and the data collection are executed.

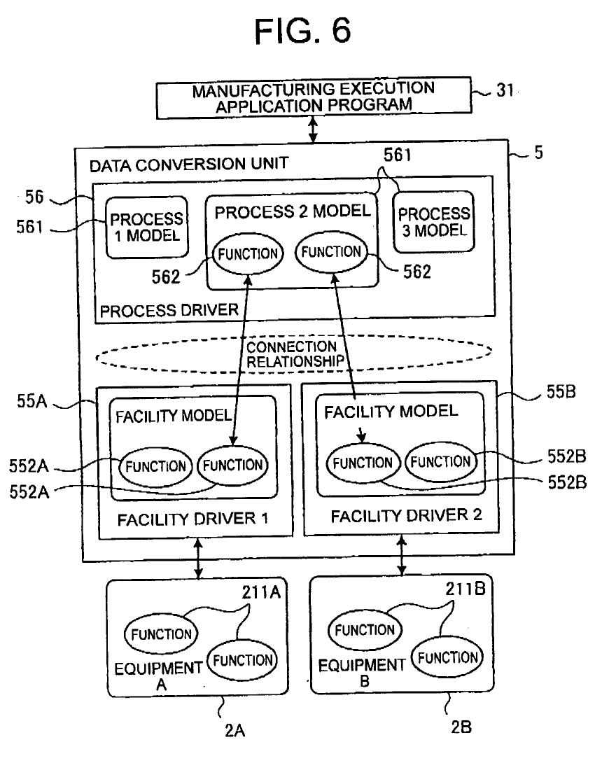

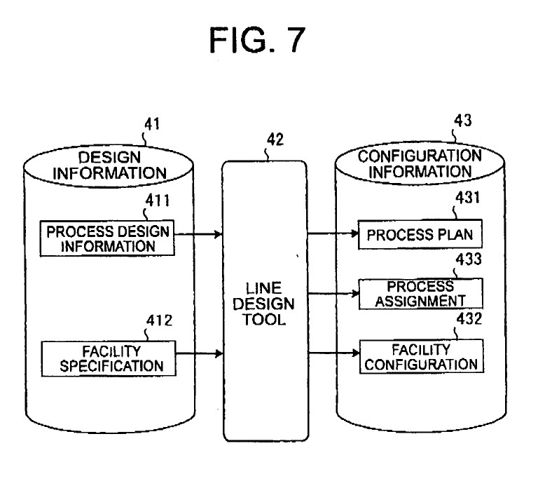

Subsequently, a more specific example of the hierarchization of the communication driver shown in FIG. 5 will be described. FIG. 6 is a diagram schematically showing a configuration of the communication driver in a case where the hierarchization of the driver is applied to the process management. FIG. 7 is a diagram showing an example of producing the function object in a case where the driver is produced with the process management as a unit.

As shown in FIG. 7, the design information 41 of the manufacturing system includes process design information 411 related to the process design of the manufacturing management and a design specification 412 related to the facility of the manufacturing management, and in this stage, the process design information 411 and the design specification 412 are not associated with each other. Thereafter, a line design tool 42 instantiates the contents of the process design information 411 and the design specification 412 which are classed based on the class diagram of the UML, and maps the instances of the respective information. More specifically, the process design information 411 is instantiated as a process plan 431, and the facility specification 412 is instantiated as a facility structure 432. The process design information 411 and the facility specification 412 are associated with each other by a process assignment 433. The processes are associated with each other between the manufacturing execution application program 31 and the equipments 2, to thereby produce the driver that can manage the equipments 2 by a process base. Also, the plural equipments 2 can be perceived as one virtual equipment from the manufacturing execution application program 31.

In an example of FIG. 6, the facility drivers 55A and 55B that are produced based on the facility structure 432 are provided for each of the equipments 2A and 2B that are made up of the combination of the machine and the device that controls the machine. The function objects 552A and 552B are produced in the corresponding functions 211A and 211B of the equipments 2A and 2B in the facility drivers 55A and 55B. Also, a process driver 56 that is produced based on the process plan 431 precedes the facility drivers 55A and 55B. In the process driver 56, a process model 561 is produced for each of given processes, and function objects 562 that realize the functions included in the process plan 431 are produced within each of the process models 561. The function objects 562 of the process driver 56 are associated with the function objects 552A and 552B of the facility drivers 55A and 55B are associated with each other based on the process assignment 433. An instruction having a process from the managing execution application program 31 as a unit is transmitted down as an instruction to the equipment 2 used in that process by the process driver 56 and the facility driver 55. Then, a reply to the instruction is returned to the manufacturing execution application program 31.

As described above, an example in which the plural equipments 2 are recognized as one virtual equipment can be applied to a process management, a stock management, are source management, or a quality management in addition to the above example.

The real equipment driver in FIG. 5 or the facility driver in FIG. 6 can be further configured as a hierarchical structure of the device driver that controls communications with the device and the equipment driver that supplies the unit data to the manufacturing execution application program 31 with the use of the device driver as in the first embodiment.

According to the second embodiment, there are advantages in that the data conversion of the data structure different between the equipment 2 and the manufacturing execution application program 31 can be realized, and the manufacturing execution application program 31 can be generalized by the hierarchized drivers.

The first and second embodiments exemplify a case in which the data conversion unit 5 is equipped with the hierarchized drivers having the function that conducts data conversion for communication between the manufacturing execution application program 31 and the equipments 2. Alternatively, the hierarchized drivers can be provided at the manufacturing execution system 3 side in which the manufacturing execution application program 31 is installed, or at the equipment 2 side. This configuration requires no data conversion unit 5 in the manufacturing system, and makes it possible to simplify the system structure.

### Third Embodiment

The access to the function objects shown in the first and second embodiments is made common irrespective of the kinds of the function objects, thereby enabling the access process to the driver to be facilitated. Under the circumstances, in the third embodiment, an example of the common interface of the drivers and the access procedure to the drivers will be described. FIGS. 8-1 to 8-9 are diagrams schematically showing the common interface of the drivers and the driver access procedure. The common interface of the drivers accesses the driver model shown in FIG. 3 and the function object model in FIG. 4 showing the function of the driver to manage the object, read and write the data, and execute the operation.

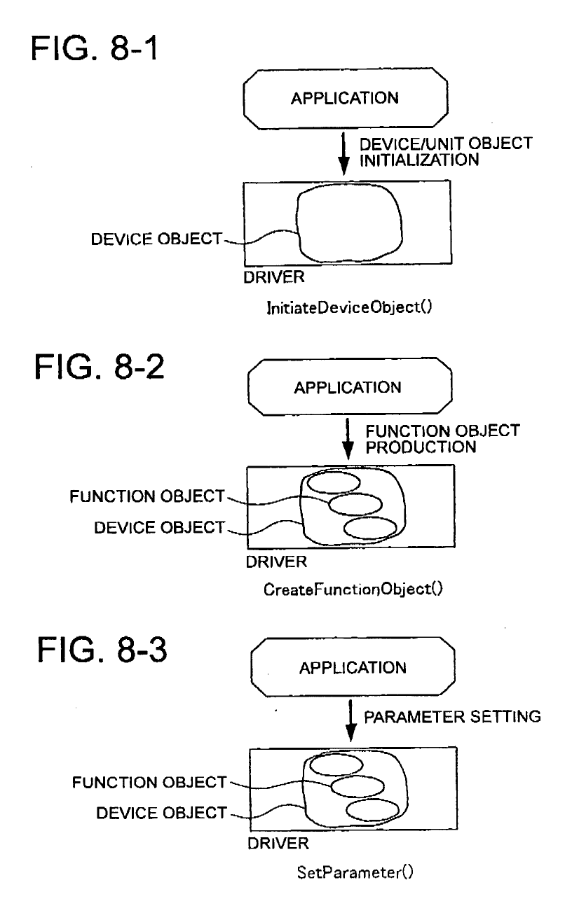

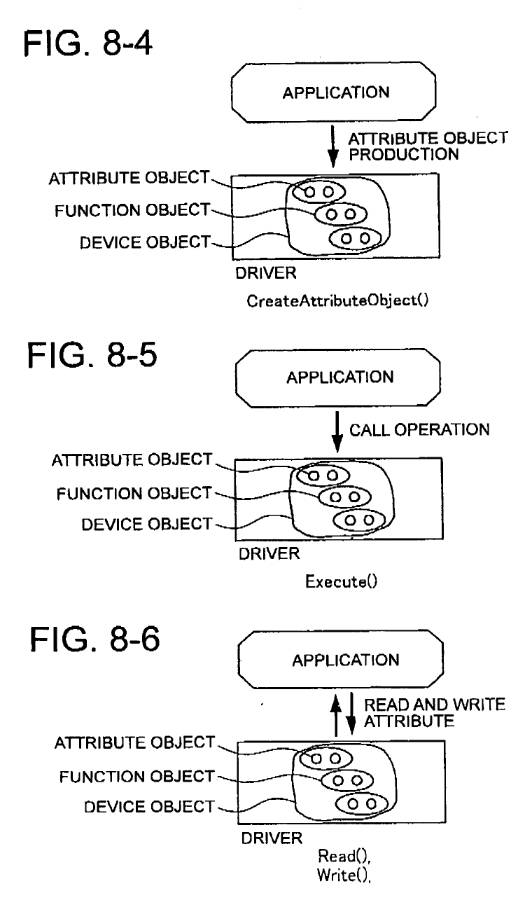

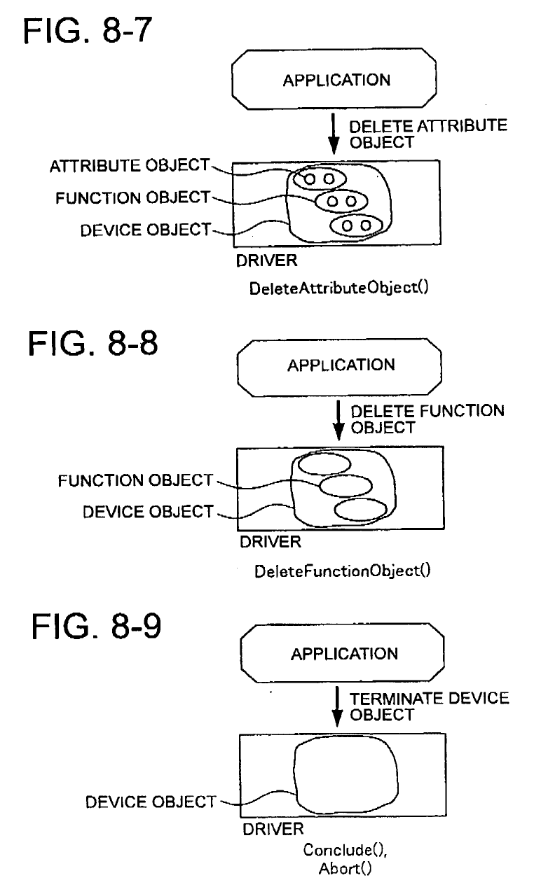

In the access procedure of the driver, the instance of the function object is created by a driver API (CreateFunctionobject( )) (FIG. 8-2) after the device and the equipment object have been first initialized by the driver API (application program interface) (InitiateDeviceObject( )) (FIG. 8-1). As a result, a side that accesses the driver is capable of obtaining the function object available by the driver. Then, a parameter such as configuration is set to the function object by the driver API (SetParameter( )) (FIG. 8-3). The parameter and the operation can be accessed from the function object, but the attribute cannot be accessed directly from the function object.

Therefore, an attribute object for accessing the attribute (for reading or writing the data) is created by the driver API (CreateAttributeObject( )) (FIG. 8-4). Thereafter, the operation of the created function object is called (driver API: Execute( )), the operation is executed (FIG. 8-5), and the value of the attribute is read and written (driver API: Read, Write( )), to access the attribute object (FIG. 8-6).

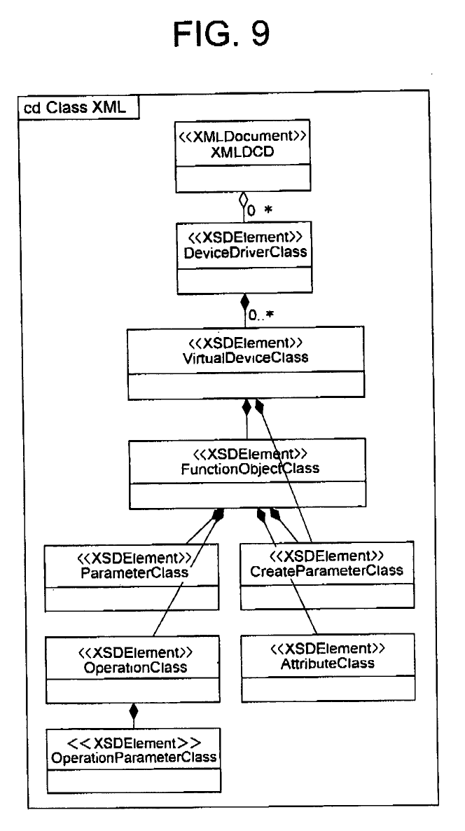

Thereafter, upon completion of the use of the driver, the driver terminating process is conducted. First, the attribute object is deleted by the driver API (DeleteAttributeObject( )) (FIG. 8-7), and the function object is then deleted by the driver API (DeleteFunctionobject( )) (FIG. 8-8). Finally, the device/equipment object is terminated by the driver API (Conclude( )) (FIG. 8-9). In FIG. 8-9, the driver API (Conclude( )) confirms whether the attribute object and the function object have been normally deleted, or not, and when the attribute object or the function object cannot be normally terminated or the driver is terminated immediately due to the system abnormality, the driver API (Abort( )) is used.

According to the third embodiment, the use of the common interface of the driver makes it possible to realize the driver API that does not influence an object to be accessed by the driver, thereby improving the portability of the driver software. Also, the specific access information on the object to be accessed by the driver is supplied as the information on the function object of the profile of the driver, and it is possible to initialize the driver based on the information on the function object of the profile, and access the individual function objects and attribute objects.

### Fourth Embodiment

The hierarchized communication drivers described in the first and second embodiments are produced based on the design information and the configuration information on the manufacturing system as described in the second embodiment. The design information and the configuration information are more likely to be described in a markup language such as an XML (extensible markup language) from the view points of saving in the form of electric data, the ease of data diversion, and the general purpose of data use. Also, when the idea of the class diagram of the UML is introduced into the data that is described in the XML format, it is possible to easily produce the function object from the design information and the configuration information. Under the circumstances, in the fourth embodiment, a description will be given of an XML data model in which the design information and the configuration information are classified according to the class diagram of the UML, and then saved in the XML format.

As described above, the function object of the communication driver in the manufacturing system is produced based on the function object model shown in FIG. 4. Therefore, the contents of the design information and the configuration information are constituted according to the function object model, and the XML data model that describes the configuration in the XML is produced. FIG. 9 is a diagram showing an example in which the XML data model for describing the design information in the XML profile is described in the UML class diagram. In this example, the XML structure is described in the stereo type of the UML, and the class names are described under the respective stereo types.

For example, <<XMLDocument>> expresses the entire XML data, and <<XSDElement>> expresses the elements of XML scheme description (XSD). Accordingly, the “XMLDCD” class represents the entire XML data of the design information. The respective classes of “DeviceDriverClass”, “VirtualDeviceClass”, and “FunctionObjectclass” are hierarchized under the “XMLDCD” class. Those classes are the elements of the XML scheme description. In this example, “DeviceDriverClass” corresponds to the drivers such as the device driver 51 and the equipment driver 52 in FIG. 3, the real equipment driver 53 and the virtual equipment driver 54 in FIG. 5. The “VirtualDeviceClass” corresponds to the virtual device within the driver such as the device object 511 and the equipment object 521 in FIG. 3, or the equipment object 531 and the virtual equipment object 541 in FIG. 5. A “CreateParameterClass” is located below the “VirtualDeviceClass”. The “FunctionObjectClass” indicates the function objects shown in FIGS. 3 and 5. As shown in the function object model of FIG. 4, the function object includes a parameter, a create parameter, an attribute, and an operation, each corresponding to “ParameterClass”, “CreateParameterClass”, “OperationClass”, and “AttributeClass”, and their information is stored in the respective classes. Those classes become the elements of the XML scheme description. In addition, the “OperationClass” has a parameter, and the “OperationParameterClass” is located below the “OperationClass”, and its information is stored therein. The class is also the element of the XML scheme description.

That is, as shown in FIG. 9, the respective classes of the DeviceDriverClass, the VirtualDeviceClass, and the FunctionObjectClass are hierarchized in the stated order and continuous to each other below the XMLDCD class. Among them, the CreateParameterClass is located below the VirtualDeviceClass, and four classes of the ParameterClass, the CreateParameterClass, the OperationClass, and the AttributeClass are arranged in parallel and are located blow the FunctionObjectClass. In addition, the OperationParameterClass is located below the OperationClass among those classes. The hierarchical structure of this type can be expressed based on the describing method of the XML data, and a relationship of the class diagram in the UML can be reflected in the XML data and described.

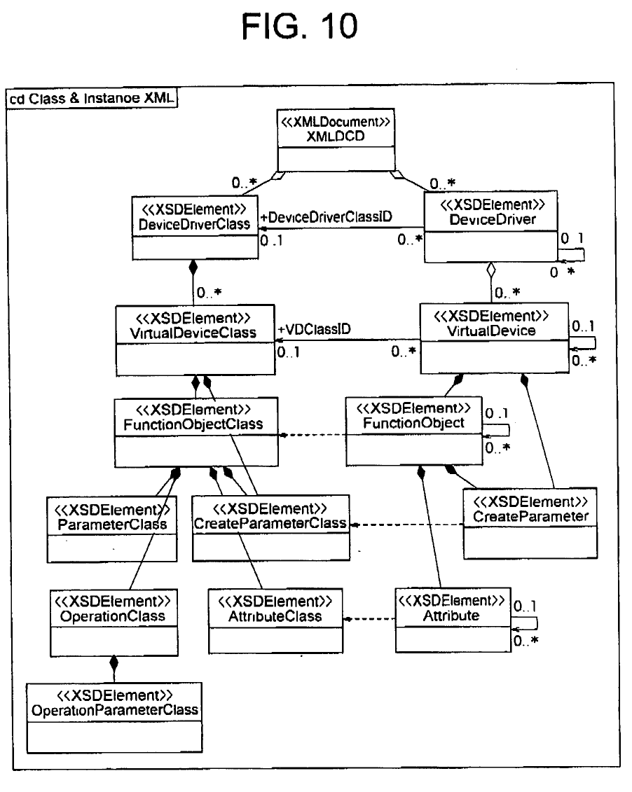

FIG. 10 is a diagram showing an example of the XML data model in which the instance information model is added to the XML data model of the design information shown in FIG. 9. In the figure, the left half is identical with the XML data model of the design information described in the UML class diagram shown in FIG. 9, and indicates the class information of the function object. The right half indicates the instance information model of the function object. The instance information model describes the information on the instance corresponding to the class information on the function object. More specifically, the instance information model stores the configuration information on the device driver of the above first or second embodiment and the virtual device of the device driver therein, and represents the information on the actual equipments 2 and a correspondence relationship with the equipment 2. Also, the instance information model indicates what function object and attribute of the lower-level driver the hierarchical driver corresponds to.

In an example of FIG. 10, “DeviceDriver”, “VirtualDevice”, “FunctionObject”, “CreateParameter”, and “Attribute” represent the instance information on “DeviceDriverClass”, “VirtualDeviceClass”, “FunctionObjectClass”, “CreateParameterClass”, and “AttributeClass”, respectively. In this example, a relationship indicative of oneself of the instance information “DeviceDriver” represents the hierarchical configuration of the device driver. Also, a relationship indicative of oneself of the instance information “VirtualDevice” represents the configurations of the real unit and the real device. For example, the relationship represents the device that constitutes the equipment. Further, a relationship indicative of oneself of the instance information “FunctionObject” represents the lower-level driver function which is called from the upper-level driver in the hierarchical driver. Also, a relationship indicative of oneself of the instance information “Attribute” represents the lower-level instance information “Attribute” which is called from the upper-level driver in the hierarchical driver. For example, the relationship represents the configuration information on the data conversion of the data conversion unit 5 that converts the device data into the equipment data or collects up the dispersed data in each of the equipments.

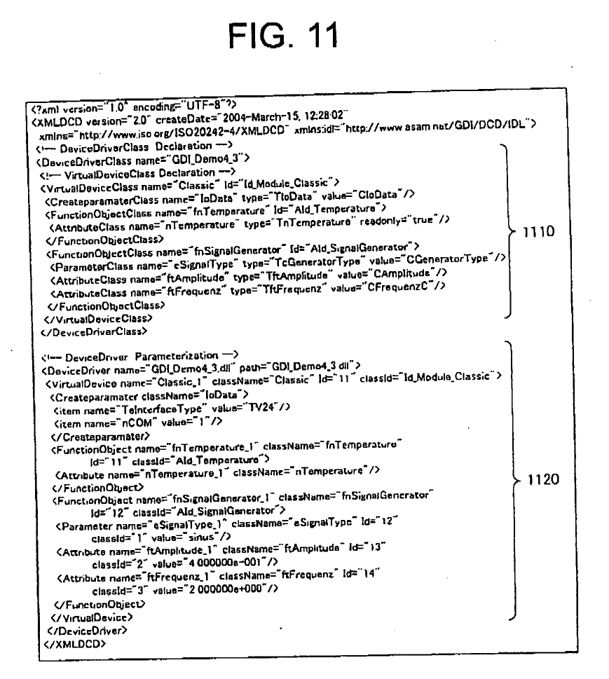

FIG. 11 is a diagram showing an example in which the design information and the configuration information are described based on the XML data model shown in FIG. 10. The entirety of FIG. 11 corresponds to the XMLDCD class. In a block 1110 within an XMLDCD tag, the hierarchical relationship (inclusion relation) between the classes shown in FIG. 9 (left half of FIG. 10) is described. In this example, the class name that is described on the lower portion of the stereo type shown in FIG. 9 is used as the title of the tag. That is, the “VirtualDeviceClass” is included within the “DeviceDriverClass”, and one “CreateParameterClass” and two “FunctionObjectClasses” are included within the “VirtualDeviceClass”. Two classes of the function objects are produced. The classes related to the parameter or the attribute are further included within the respective “FunctionObjectClasses”.

On the other hand, the instance information corresponding to the class information of the block 1110 is described in a block 1120 within the XMLDCD tag. In this example, the title that is described on the lower portion of the stereo type of the instance information model which is described on the right half of FIG. 10 is used as the tile of the tag. That is, the “VirtualDevice” is included within the “DeviceDriver”, and one “CreateParameter” and two “FunctionObjects” are included within the “VirtualDevice”. The contents related to the attribute and the parameter are included within the “CreateParameter” and the “FunctionObject”.

As shown in FIG. 11, the parameter and the attribute of the function of the driver to be produced, and the item of the operation are defined in the description of the class information represented in the block 1110. The setup of the parameters corresponding to the kinds of the respective produced drivers is defined in the description of the instance information represented in, the block 1120. Also, as shown in FIG. 10, the title of the tag indicative of the class in the XML data and the title of the tag indicative of the instance information are associated with each other in advance. As a result, the XML data of the design information and the configuration information, which is classified based on the function, object model is referred to at the time of converting the data by the aid of the driver. The commands (processings) of the abstract or common contents with respect to the equipment and the device are converted into the commands (processings) of the specific contents corresponding to the individual equipments or devices, there by enabling an access to the equipments or devices by means of the driver.

According to the fourth embodiment, since the data conversion of the communication driver is conducted by using the XML profile model of the design information and the configuration information, it is possible to convert the processing of the abstract or common contents into the processing of the specific contents of the equipment 2. Also, the use of the XML data model makes it possible to support or automate the production of the data conversion function in the driver.

### Fifth Embodiment

The protocol interface between the device driver and the device of the equipment is described by an interface definition language (hereinafter referred to as “IDL” (interface definition language), for example, according to the communication protocol such as the CORBA (common object request broker architecture) of the OMG (object management group) or the DCOM (distributed component object model) of Microsoft. However, the IDL cannot describe the instance information, and also cannot be so extended as to describe the instance information. Under the circumstances, in a fifth embodiment, a description will be given of a communication driver that is capable of describing the instance information even by the IDL by mapping the IDL with the XML.

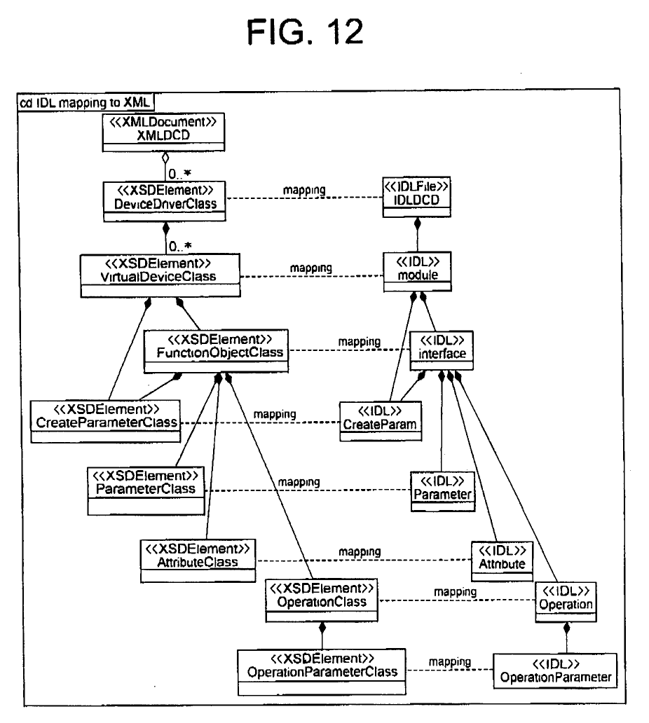

FIG. 12 is a diagram showing an example of a mapping model as to the design information of the IDL and the XML data. The left half of FIG. 12 is identical with that of the XML data model shown in FIG. 9, and the right half shows the description model of the IDL which is classed based on the class diagram of the UML. The IDLDCD class represents the entire IDL data of the design information. The “module” class exists under the IDLDCD class, and the “interface” class and the “CreateParam” class exist under the “module” class. Also, the “CreateParam” class, the “parameter” class, the “Attribute” class, and the “Operation” class exist under the “interface” class, and the “OperationParameter” class also exists under the “Operation” class. The IDLDCD class, the “module” class, the “interface” class, the “CreateParam” class, the “CreatePrama” class, the “parameter” class, the “Attribute” class, the “Operation” class, and the “OperationParameter” class are associated (mapped) with the “DeviceDriverClass”, the “VirtualDeviceClass”, the “FunctionObjectClass”, the “CreateParameterClass”, the “ParameterClass”, the “AttributeClass”, the “OperationClass”, and the “OperationParameterClass” of the XML data model, respectively.

Referring to FIGS. 12 and 8, the description contents of the IDL can be associated with the class of the XML data model, and the instance information corresponding to the individual equipments can be further referred to from the class of the XML data model.

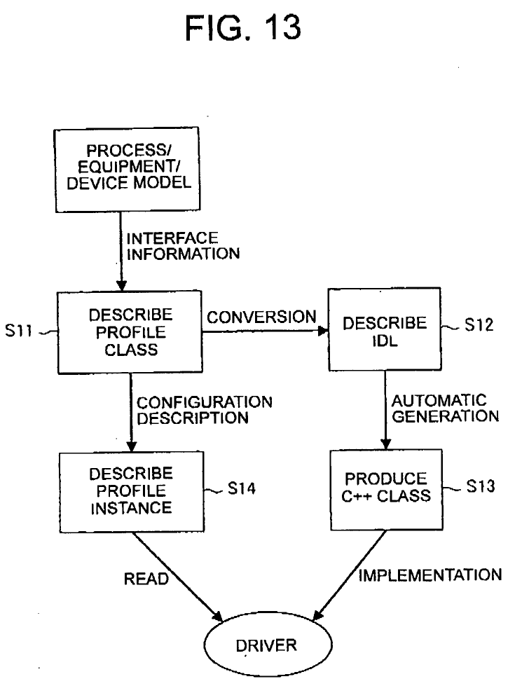

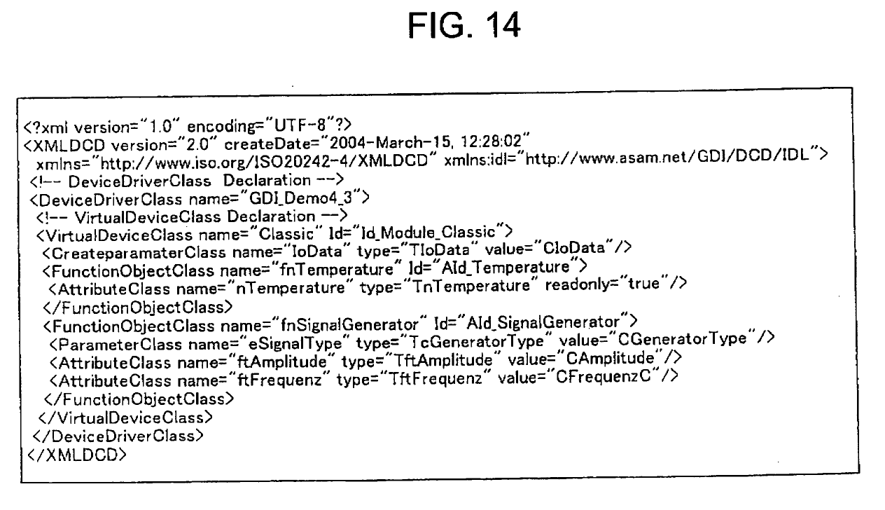

Subsequently, a description will be given of a method of producing the protocol interface portion of the communication driver. FIG. 13 is a diagram showing an example of a producing procedure and a setting procedure of the protocol interface portion of the communication driver which is capable of referring to the instance information. First, the class information of the XML profile which is information indicative of the general property to be accessed is described based on the interface information of the model to be accessed of the driver such as the process, the equipment, and the device by a creator of the manufacturing system (or the individual devices or equipments) (Step S11). FIG. 14 is a diagram showing an example of the description of the XML profile of the interface information.

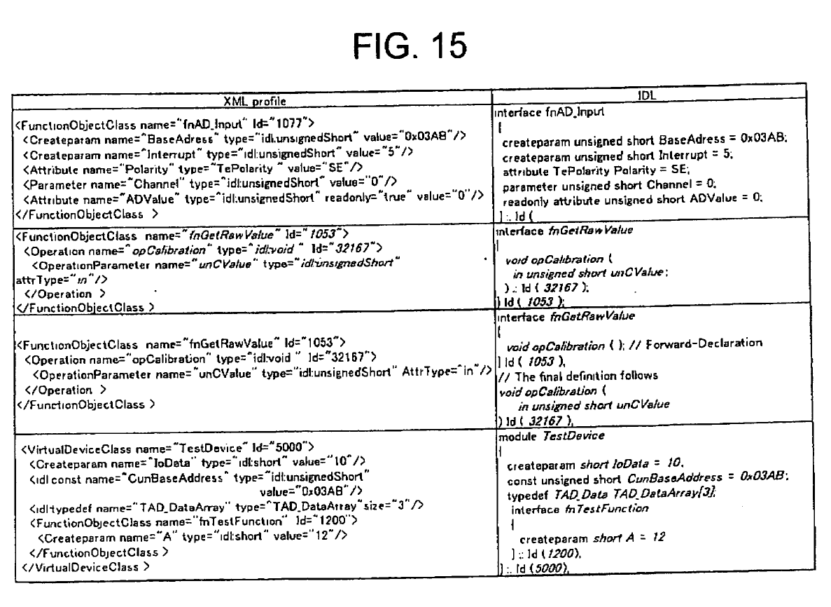

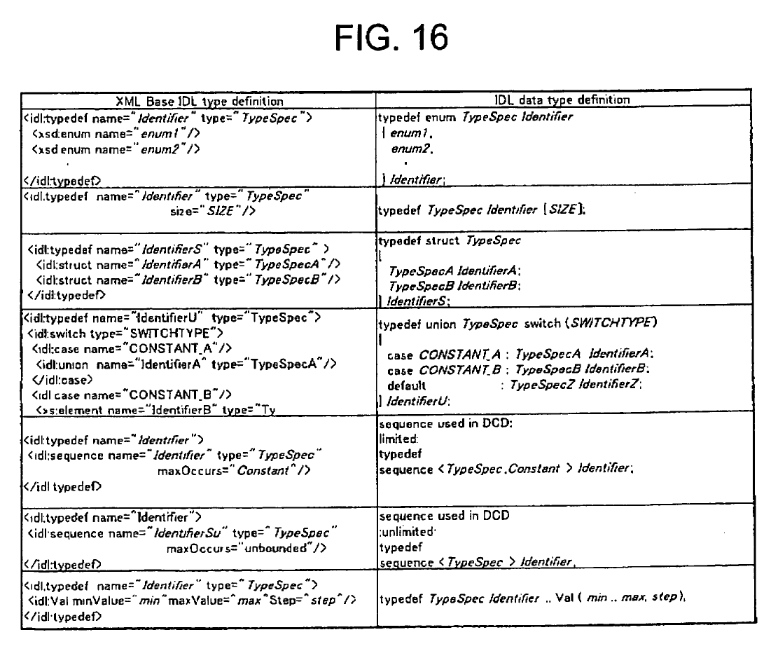

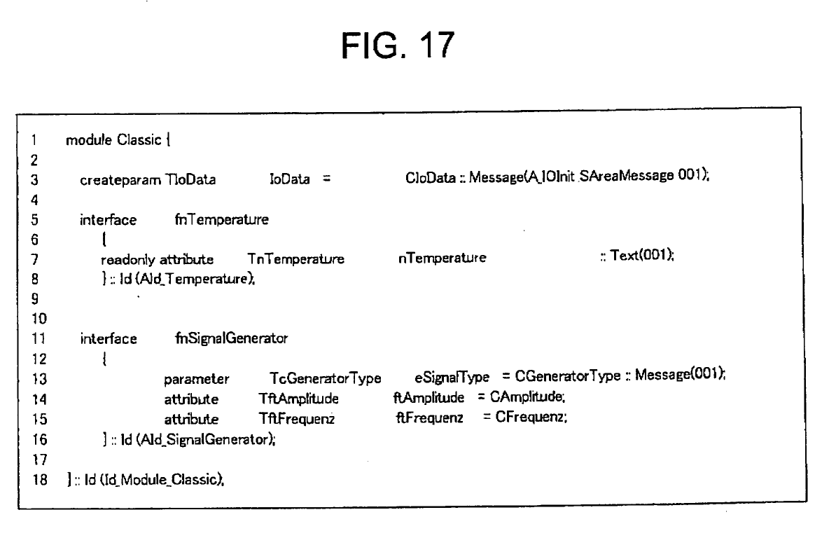

Then, the class information of the described XML profile is automatically converted into the description of the IDL by a program that executes the mapping model of the IDL and XML data shown in FIG. 12 (Step S12). FIG. 15 is a diagram showing an example of the description pattern of the XML profile of the IDL interface portion, and FIG. 16 is a diagram showing an example of the description rule in the XML profile of the IDL data type declaration. The left sides of those figures show the description example of the XML profile, and the right sides thereof show an example in which the corresponding contents are described in the IDL according to the model of FIG. 12. Because the data type declaration of FIG. 16 depends on the implementation of data, the IDL data type declaration per se can be described in the XML profile. In the case of using the interface description language of the XML base such as a WSDL (web services description language), it is possible to use the XML data type as it is. The description of the class information of the XML profile is converted into the IDL description according to the XML profile-IDL mapping rule shown in FIGS. 15 and 16. FIG. 17 is a diagram showing an example of the IDL description corresponding to the description of the class information of the XML profile of FIG. 14.

Thereafter, C++ class is produced from the converted ILD description according to the platform (operating system) of the driver software in the conventional known method (Step S13), and the driver is implemented.

On the other hand, in the configuration setting to be accessed of the implemented driver, the description of the class information on the XML profile is read by configuration setting means such as a configuration setting software to produce the template of the configuration information. The template is produced according to an XML data model shown in FIG. 10 which associates the class information of the XML profile with the instance information. Then, the configuration information indicative of the instance information on the individual equipments is set according to the template (Step S14). The set configuration information is described in the XML as the instance information of the XML profile, and read at the time of starting up the driver.

The communication driver including the protocol interface portion is produced in the above manner. The driver that is produced and implemented in the above procedure produces a required object from the instance information of the read configuration information, and supplies the information on the application object. Also, the manufacturing execution application program directly reads the configuration information, or acquires the object information from the driver to initialize the driver and access an object to be accessed.

The IDL description in Step S12 and C++ class generation in Step S13 can be mutually converted in the conventional known method. Also, the class description of the XML profile in Step S11 and the IDL description in Step S12 can be also mutually converted based on the XML profile-IDL mapping rule shown in FIGS. 12, 15, and 16 described above. For that reason, after the creator of the manufacturing system (or individual devices or equipments) first conducts the IDL description in Step S12, the creator can implement the driver from the production of the C++ class in Step S13, and conduct the instance description of the XML profile from the class description of the XML profile in Steps S11 and S14 to read the instance description by the driver. Also, in the driver that has already been implemented in the C++ class, it is possible that the C++ class is converted into the IDL description in Step S12, and also described in the class information of the XML profile in Step S11, and further, the instance description of the XML profile is conducted to produce the communication driver including the protocol interface portion.

According to the fifth embodiment, the IDL shows only the type of the interface of the object, but cannot describe the configuration of the instantiated object. However, the IDL describes the configuration of the interface and the instance of the object by the XML. As a result, it is possible to provide the manufacturing execution application with the equipment that constitutes the manufacturing system, the interface of its function object, and the configuration information, and there is an advantage in that it is possible to support or automate the setting for accessing the manufacturing unit by the manufacturing application. Also, the mapping configuration for data conversion required in this situation can be described.

Also, the sharing of the driver can be realized, to thereby streamline the development of the driver. Further, the configuration setting software that has been conventionally produced individually can be also shared.

In the above fourth and fifth embodiments, the XML is used as the data model that describes the class information and the instance information of the driver. However, the present invention is not limited to the XML when the data contents can be described according to the data model shown in FIG. 10.

### INDUSTRIAL APPLICABILITY

As has been described above, the communication driver according to the present invention is suitable for conversion of data that is communicated with the equipment having a control section which controls the respective machines such as a transport machine, a manufacturing machine, and an inspection machine, for example, in a manufacturing facility.

1. A communication driver that converts data, which is communicated between a management unit and a facility unit in a manufacturing system,
the facility unit equipped with a device that controls a facility machine based on an instruction from the management unit and the management unit having a management application program that manages the facility unit being connected to the facility machine that conducts a given processing via a network,
an output from the management application program being converted into a format that can be processed by the facility unit to make the facility unit execute the given processing,
the communication driver comprising:
a device driver that is provided for each kind of the devices arranged in the manufacturing system, and controls communications with the device; and
a unit driver that is provided for each kind of facility machines arranged in the manufacturing system, and accesses the facility machine to be accessed with the use of the device driver according to an instruction from the management application program,
the device driver and the unit driver being hierarchized,
wherein the device driver and the unit driver are produced by a function object that is produced to have a given parameter, an attribute, and an operation for each function of the device and the facility machine corresponding to the respective drivers,
wherein contents of a function of the device driver or the unit driver are set as class information described according to a model of the function object, and the contents of the function or a set value is described in a markup language according to a data model in which the set value of each device driver or unit driver is classified in association with the class information and set as the instance information and
wherein the device driver or the unit driver maps the class information that is obtained by classifying description contents of a communication interface of the function object, which are described in an interface description language based on a description model of the interface description language, and the class information of the data model, and refers to configuration information including an instance corresponding to the function object obtained from the mapping result and the data model, to thereby process the communicated data.

2. (canceled)

3. (canceled)

4. (canceled)

5. (canceled)

6. (canceled)

7. (canceled)

8. A communication driver that converts data, which is communicated between a management unit and a plurality of facility units in a manufacturing system,
the plurality of facility units that conduct given processings and the management unit having a management application program that manages the facility units being connected to each other via a network,
an output from the management application program being converted into a format that can be processed by the facility units to make the facility units execute the given processings,
the communication driver comprising:
a virtual unit driver that shows the plurality of facility units as one virtual unit in the management application program; and
a real unit driver that is provided for each of the facility units, controls a communication with the facility unit, and accesses the facility unit to be accessed according to an instruction from the virtual unit driver,
the virtual unit driver and the real unit driver being hierarchized,
wherein the real unit driver is produced by a function object that is produced to have a given parameter, an attribute, and an operation for each function of the corresponding facility unit,
wherein the virtual unit driver is produced by a function object that is produced to have a given parameter and an attribute for each function obtained by abstracting functions of the facility units which are arranged in the manufacturing system,
wherein contents of a function of the virtual unit driver or the real unit driver are set as class information described according to a model of the function object, and the contents of the function or a set value is described in a markup language according to a data model in which the set value of each virtual unit driver or real unit driver is classified in association with the class information and set as instance information, and
wherein the virtual unit driver or the real unit driver maps the class information that is obtained by classifying description contents of a communication interface of the function object, which are described in an interface description language based on a description model of the interface description language, and the class information of the data model, and refers to configuration information including an instance corresponding to the function object obtained from the mapping result and the data model, to thereby process the communicated data.

9. (canceled)

10. (canceled)

11. (canceled)

12. (canceled)

13. A communication driver according to claim 8, wherein the virtual unit driver manages a processing that is executed by the facility units based on the specification of the facility units in association with a process that is executed in the manufacturing system based on the process design information of the manufacturing system.

14. (canceled)

15. (canceled)

16. A communication driver according to claim 13,
wherein each of the facility units includes a facility machine that conducts a given processing, and a device that controls the facility machine based on an instruction from the management unit,
wherein the real unit driver comprises:
a device driver that is provided for each kind of devices arranged in the manufacturing system, and controls communications with the device; and
a unit driver that is provided for each kind of facility machines arranged in the manufacturing system, and accesses the facility machine to be accessed with the use of the device driver according to an instruction from the management application program, and
wherein contents of a function of the device driver, the unit driver, or the real unit driver are set as class information described according to a model of the function object, and the contents of the function or a set value is described in a markup language according to a data model in which the set value of each device driver, unit driver, or real unit driver is classified in association with the class information and set as instance information.
